(19) United States
(12) Patent Application Publication
(10) Pub. No.: US 2009/0087682 A1
(43) Pub. Date: Apr. 2, 2009

(54) METHOD FOR PRODUCING QUASI-CRYSTALLINE PARTICLE DISPERSED ALLOY CLAD MATERIAL, METHOD FOR PRODUCING QUASI-CRYSTALLINE PARTICLE DISPERSED ALLOY BULK MATERIAL, QUASI-CRYSTALLINE PARTICLE DISPERSED ALLOY CLAD MATERIAL, AND QUASI-CRYSTALLINE PARTICLE DISPERSED ALLOY BULK MATERIAL

(76) Inventors: Motoki HISHIDA, Saitama (JP); Masashi Fujita, Saitama (JP); Seiichi Koike, Saitama (JP)

Correspondence Address: ARENT FOX LLP, 1050 CONNECTICUT AVENUE, N.W., SUITE 400, WASHINGTON, DC, 20036, US

(21) Appl. No.: 12/058,012

(22) Filed: Mar. 28, 2008

(30) Foreign Application Priority Data
Mar. 29, 2007 (JP) 2007-088469

(51) Int. Cl. B32B 15/01; B05D 1/12; C22C 45/08

(52) U.S. Cl. 428/650; 427/180; 148/403

(57) ABSTRACT

To provide a method for producing a quasi-crystalline particle dispersed alloy clad material which can be formed into a thick plate or a member for a structure having a specific shape, in particular, a complicated shape while maintaining quasi-crystalline particles, and can be enhanced in strength when used as a member for a structure, in particular, in strength in a high temperature environment. According to the method for producing a quasi-crystalline particle dispersed alloy clad material 1 of the present invention, a quasi-crystalline particle dispersed alloy clad material 1 is produced by forming a quasi-crystalline particle dispersed alloy containing quasi-crystalline particles dispersed in a matrix, onto a base material 2 by a clad layer forming apparatus 100 at a temperature lower than or equal to a decomposition temperature of the quasi-crystalline particles.

### BACKGROUND OF THE INVENTION

1. Field of the Invention

The present invention relates to metal materials to be used for transportation equipment and electronics, and more specifically, to a method for producing quasi-crystalline particle dispersed alloy clad material by forming a quasi-crystalline particle dispersed alloy layer in which quasi-crystalline particles are dispersing in a matrix material, a method for producing quasi-crystalline particle dispersed alloy bulk material, a quasi-crystalline particle dispersed alloy clad material, and a quasi-crystalline particle dispersed alloy bulk material.

2. Description of the Prior Art

Metal materials are used in various applications as structural materials for such applications as transportation equipment like railways and vehicles. Although recently there is a trend of replacing metal materials with plastic materials such as FRP to reduce the weight of equipment, the demand for metal materials have diversified in view of the spread of electronics, the rise in leisure industries, the environment, and energy savings.

In particular, recently, by applying surface treatment to a base material of metal (referred to as “metal base material”), application development equipped with multi-functionality such as corrosion resistance and durability in addition to electric conduction and heat conduction that cannot be sufficiently realized by plastic has been promoted.

However, structural metal materials could break during use. It is known that a fracture of structural metal materials occurs in most cases due to material's fatigue, and most of the fatigue fractures are caused by propagation of cracks generated on the surfaces of a member, that is, surfaces of a metal base material.

As a method for preventing propagation of cracks on the surface of a metal base material, the metal material's strength has to be enhanced. Strengthening a metal material can be realized by a method such as solid solution strengthening and crystalline particle refinement.

Instead of the method described above, strengthening a metal material strength can be realized by dispersing into the matrix material reinforcement particles which maintain their particle atomic structures even at high temperatures (hereinafter, referred to as “dispersion reinforcement”). With this method, in particular, material's strength at high temperatures can be enhanced.

In addition, there is a so-called metal matrix ceramics composite material obtained by applying onto a metal base material heat-shielding coating made of a heat insulating material such as ceramics. Such a metal matrix ceramics composite material is a dispersion reinforced material which has a matrix material made of the same material as the metal base material, and has a heat insulating layer containing dispersed hard particles of a reinforcing phase. By using this dispersion reinforced material, the affinity of the heat insulating layer and the metal base material can be satisfactory, and the strength at high temperatures can be enhanced.

Further, according to Japanese Laid-open Patent Application H06-25696, a metal matrix ceramics composite material provided with an a intermediate layer for preventing delamination between the metal base material and the heat insulating layer of the metal matrix ceramics composite material has also been developed.

As a surface treatment technique to add various functions to the metal base material, for example, generally, a chromium plated layer for improving corrosion resistance, a noble metal layer using a noble metal such as Au or Pt durable in a corrosive environment, a ceramics layer using chemically stable ceramics such as Al₂O₃, and a carbon layer using carbon durable in a corrosive environment are coated onto the metal base material. In addition, it is also common that a DLC (Diamond-Like Carbon) layer for improving tribology properties of the metal base material and a heat insulating layer for improving the heat resistance of the metal base material are coated.

The above-described coating of the heat insulating layer can suppress a temperature rise of the metal base material and avoid strength lowering by coating a heat insulating material such as ceramics onto the metal base material. That is, the heat resistance of a member for structure made of this metal base material is improved.

Normally, to coat the above-described various layers onto a metal base material, for example, as described in pp. 125-129 in “Thermal spraying technique handbook” edited by the Japan Thermal Spraying Society, Techno Consultants Inc., May 1998, by Shigeki Isa and “Cold spray technology” Yousha Gijutsu, Kazuhiko Sakaki; Feb. 5, 2002, vol. 21, No. 3, pp. 29-38, gas thermal spraying such as flame spraying (2000 to 3000° C.) or D-gun process or electric spraying such as arc spraying (2000 to 5000° C.) or plasma spraying (2000 to 10000° C.) is performed. In all cases, gases whose temperatures are extremely high are used, and by using such high temperature gases, the sprayed materials are provided with high energy and their adhesion to the metal base material is improved.

Recently developed metal materials according to the above-described dispersion reinforcement include, for example, an Mg—Zn—Y-based alloy described in Japanese Laid-Open Patent Application No. 2005-113234. This Mg—Zn—Y-based material is a dispersion reinforced metal material obtained by having quasi-crystalline particles precipitated during cooling of the molten metal thereof. These precipitated quasi-crystalline particles function to reinforce a ductile matrix, and can stably maintain their atomic structures at relatively high temperatures. Accordingly the alloy of a Mg—Zn—Y-based material produced in the above described way has high fracture strengths. In this Mg—Zn—Y-based alloy, quasi-crystalline particles metallurgically precipitate in the matrix and fine spherical particles can be homogeneously dispersed. Therefore, as described in Japanese Laid-Open Patent Application No. 2005-113234, by having dispersed fine spherical particles with particle sizes smaller than or equal to 100 nanometers as isolated particles at a high volume fraction up to about 80%, improvement in heat resistance and wear resistance for the metal base material is realized. By using this metal material as an insulating layer, the strength of a structural member, in particular, at high temperatures can be enhanced.

As another recently developed metal material based on the dispersion reinforcement, there is an aluminum base alloy described in Japanese Laid-Open Patent Application No. 2006-274311. This aluminum base alloy includes an element for aiding formation of quasi-crystalline particles, an element for aiding formation of quasi-crystalline particles and an element for delaying precipitation of quasi-crystalline particles and these elements are within a predetermined composition range. As a result, this aluminum base alloy is excellent in mechanical properties, in particular, its strength at high temperatures. Therefore, it is considered possible that the strength of a structural member, in particular, at high temperatures can be enhanced by using this metal material as a heat insulation layer.

The quasi-crystalline particles described in Japanese Laid-Open Patent Application No. 2005-113234 and Japanese Laid-Open Patent Application No. 2006-274311 are structures found for the first time, in 1984, in an Al-14% Mn alloy, and as their properties, rotation symmetry that conventional crystal materials did not show is shown due to their icosahedral structures. Quasi-crystalline particles do not have periodic structures like conventional crystal materials, so that they have extremely high hardness. For example, the Vickers hardness reaches 520 Hv in an Al—Li—Cu-based alloy, and reaches 1070 Hv in an Al—Ru—Cu-based alloy.

When strength is enhanced by solid solution strengthening or crystalline particle refinement, the structures and properties thereof are hardly maintained at high temperatures, and the effect of strength enhancement at high temperatures is made small.

In dispersion reinforcement, fine and homogeneous dispersion of reinforcing particles at a high volume fraction is a key to strength enhancement. However, inclusion of an especially high volume fraction of reinforcing fine particles dispersed homogeneously is very difficult.

The metal matrix ceramics composite material described in Japanese Laid-Open Patent Application No. H06-25696, etc., also requires mechanically combining ceramics as described above and the particle sizes of reinforcing particles are as large as several micrometers, and it is difficult to have the reinforcing particles dispersed homogeneously and spherically. Therefore, the metal matrix ceramics composite material is very brittle, and to secure ductility, inclusion of a high volume fraction of reinforcing particles is impossible.

A chromium plated layer is not preferable in view of the environmental issue regarding wastewater treatment, etc., recently, and a DLS layer and a heat insulating layer of ceramics pose a problem in adhesion to the metal base material. High strength cannot be maintained by using these conventional layers in a high temperature environment.

The alloys containing quasi-crystalline particles described in Japanese Laid-Open Patent Application No. 2005-113234 and Japanese Laid-Open Patent Application No. 2006-274311 are very brittle although their hardness is high. Accordingly these alloys cannot be used in a single phase to form a thick plate or a member for a structure having a specific shape, in particular, a complicated shape, and if thermal spraying described in pp. 125-129 in “Thermal spraying technique handbook” edited by the Japan Thermal Spraying Society, Techno Consultants Inc., May 1998, by Shigeki Isa and “Cold spray technology” Yousha Gijutsu, Kazuhiko Sakaki; Feb. 5, 2002, vol. 21, No. 3, pp. 29-38 is performed, quasi-crystalline particles disappear and a desired strength cannot be obtained.

The present invention was made in view of the above-described problems, and an object thereof is to provide a method for producing a quasi-crystalline particle dispersed alloy clad material, a method for producing a quasi-crystalline particle dispersed alloy bulk material, a quasi-crystalline particle dispersed alloy clad material, and a quasi-crystalline particle dispersed alloy bulk material which realize formation of a thick plate or a member for a structure having a specific shape, in particular, a complicated shape while including quasi-crystalline particles, and can enhance strength in use as a member for a structure, in particular, at high temperatures.

### SUMMARY OF THE INVENTION

A method for producing a quasi-crystalline particle dispersed alloy clad material of the present invention that solves the above-described problem is characterized in that a quasi-crystalline particle dispersed alloy clad material is produced by forming a quasi-crystalline particle dispersed alloy layer obtained by having quasi-crystalline particles precipitated and dispersed in a matrix, onto a base material at a temperature lower than or equal to a decomposition temperature of the quasi-crystalline particles by a clad layer forming apparatus.

Thus, in the method for producing a quasi-crystalline particle dispersed alloy clad material of the present invention, by forming a quasi-crystalline particle dispersed alloy containing quasi-crystalline particles dispersed in the matrix, onto a base material at a temperature lower than or equal to the decomposition temperature of the quasi-crystalline particle by a clad layer forming apparatus, a layer of the quasi-crystalline particle dispersed alloy (hereinafter, referred to as “quasi-crystalline particle dispersed alloy layer”) can be formed while maintaining the structures of the quasi-crystalline particles without breaking the same. That is, a quasi-crystalline particle dispersed alloy clad material containing a base material and a quasi-crystalline particle dispersed alloy layer that maintains quasi-crystalline particles, formed on the surface of the base material, can be produced. By forming the quasi-crystalline particle dispersed alloy on the surface of the base material by using a clad layer forming apparatus, even if the shape of the base material is complicated, a quasi-crystalline particle dispersed alloy layer can be formed on the surface by following the shape. Further, by forming the quasi-crystalline particle dispersed alloy layer containing quasi-crystalline particles on the surface of the base material, a quasi-crystalline particle dispersed alloy clad material whose strength in use as a structural member, in particular at high temperatures, is enhanced, can be produced.

In the present invention, it is preferable that the quasi-crystalline particle dispersed alloy layer is formed of a quasi-crystalline particle dispersed alloy in the solid phase condition at a temperature lower than or equal to the decomposition temperature of the quasi-crystalline particle.

Thus, by forming the quasi-crystalline particle dispersed alloy layer on the surface of the base material in a solid phase condition at a temperature lower than or equal to the decomposition temperature of the quasi-crystalline particles, a quasi-crystalline particle dispersed alloy clad material containing quasi-crystalline particles can be reliably produced.

In the present invention, the quasi-crystalline particle dispersed alloy is preferably an aluminum base alloy, and the matrix is an aluminum crystalline phase or an aluminum supersaturated solid solution phase.

Accordingly, a quasi-crystalline particle dispersed alloy clad material including a quasi-crystalline particle dispersed alloy layer made of an aluminum base alloy, formed onto a base material, can be produced.

In the present invention, the clad layer forming apparatus is preferably a cold sprayer. By using a cold sprayer as the clad layer forming apparatus, without breaking the structures of the quasi-crystalline particles, a quasi-crystalline particle dispersed alloy layer can be formed on the surface of a base material that still maintains the atomic structures of the quasi-crystalline particles and the quasi-crystalline particle dispersed alloy layer containing quasi-crystalline particles can be more reliably produced.

A method for producing a quasi-crystalline particle dispersed alloy bulk material of the present invention is a method in which a quasi-crystalline particle dispersed alloy bulk material is produced by using a quasi-crystalline particle dispersed alloy clad material produced by any of the above-described methods for producing a quasi-crystalline particle dispersed alloy clad material, wherein the quasi-crystalline particle dispersed alloy bulk material is produced by removing the base material from the quasi-crystalline particle dispersed alloy clad material.

Thus, in the method for producing a quasi-crystalline particle dispersed alloy bulk material of the present invention, by removing the base material from a quasi-crystalline particle dispersed alloy clad material produced according to the method for producing a quasi-crystalline particle dispersed alloy clad material of the present invention, a quasi-crystalline particle dispersed alloy bulk material made of only the quasi-crystalline particle dispersed alloy containing quasi-crystalline particles can be produced. Therefore, it can be produced as a thick plate or a structural member having a specific shape, in particular, a complicated shape made of only the quasi-crystalline particle dispersed alloy bulk material. The quasi-crystalline particle dispersed alloy bulk material produced according to the method for producing a quasi-crystalline particle dispersed alloy bulk material of the present invention is made of only a quasi-crystalline particle dispersed alloy containing quasi-crystalline particles, so that strength when used as a member for a structure, in particular, strength in a high temperature environment can be enhanced.

The quasi-crystalline particle dispersed alloy clad material of the present invention is formed by forming a quasi-crystalline particle dispersed alloy containing quasi-crystalline particles dispersed in a matrix, onto a base material.

Thus, the quasi-crystalline particle dispersed alloy clad material of the present invention has a quasi-crystalline particle dispersed alloy layer containing quasi-crystalline particles, so that strength when used as a member for a structure, in particular, strength in a high temperature environment can be enhanced.

In the present invention, the quasi-crystalline particle dispersed alloy is preferably formed in a solid state at a temperature lower than or equal to the decomposition temperature of the quasi-crystalline particles.

Thus, the quasi-crystalline particle dispersed alloy on the quasi-crystalline particle dispersed alloy clad material of the present invention is formed in a solid state at a temperature lower than or equal to the decomposition temperature of the quasi-crystalline particles, so that without breaking the structures of the quasi-crystalline particles, a quasi-crystalline particle dispersed alloy layer which maintains the structures can be formed. Therefore, strength of the quasi-crystalline particle dispersed alloy clad material when used as a member for a structure, in particular, strength in a high temperature environment can be enhanced.

In the present invention, the quasi-crystalline particle dispersed alloy is preferably an aluminum base alloy, and the matrix is preferably an aluminum crystalline phase or an aluminum supersaturated solid solution phase.

Accordingly, a quasi-crystalline particle dispersed alloy clad material having a quasi-crystalline particle dispersed alloy layer made of an aluminum base alloy formed onto a base material can be formed.

A quasi-crystalline particle dispersed alloy bulk material of the present invention is produced by removing a base material after forming a quasi-crystalline particle dispersed alloy containing quasi-crystalline particles dispersed in a matrix onto the base material.

Thus, in the quasi-crystalline particle dispersed alloy bulk material of the present invention, the base material is removed from the quasi-crystalline particle dispersed alloy clad material, so that it can be formed into a thick plate or a member for a structure having a specific shape, in particular, a complicated shape made of only the quasi-crystalline particle dispersed alloy bulk material. The quasi-crystalline particle dispersed alloy bulk material is made of only a quasi-crystalline particle dispersed alloy containing quasi-crystalline particles, so that strength when used as a member for a structure, in particular, strength in a high temperature environment can be enhanced.

In the present invention, the quasi-crystalline particle dispersed alloy is preferably formed in a solid state at a temperature lower than or equal to the decomposition temperature of the quasi-crystalline particles.

Thus, the quasi-crystalline particle dispersed alloy layer is formed of the quasi-crystalline particle dispersed alloy in a solid state at a temperature lower than or equal to the decomposition temperature of the quasicrystallline particles, so that a quasi-crystalline particle dispersed alloy bulk material reliably containing quasi-crystalline particles can be formed.

In the present invention, the quasi-crystalline particle dispersed alloy is preferably an aluminum base alloy, and a matrix is preferably an aluminum crystalline phase or an aluminum supersaturated solid solution phase.

Accordingly, a quasi-crystalline particle dispersed alloy bulk material having a quasi-crystalline particle dispersed alloy layer made of an aluminum base alloy formed onto a base material can be produced.

According to the method for producing a quasi-crystalline particle dispersed alloy clad material of the present invention, a quasi-crystalline particle dispersed alloy is layer formed onto a base material at a temperature lower than or equal to the decomposition temperature of the quasi-crystalline particles, so that while leaving the quasi-crystalline particles, a quasi-crystalline particle dispersed alloy clad material as a thick plate or a member for a stricture having a specific shape, in particular, a complicated shape can be produced. In this quasi-crystalline particle dispersed alloy clad material, the quasi-crystalline particle dispersed alloy layer containing quasi-crystalline particles is formed and the strength at high temperatures can be enhanced.

According to the method for producing a quasi-crystalline particle dispersed alloy bulk material of the present invention, a base material is removed from the quasi-crystalline particle dispersed alloy clad material, so that a quasi-crystalline particle dispersed alloy bulk material as a thick plate or a member for a structure having a specific shape, in particular, a complicated shape made of only a quasi-crystalline particle dispersed alloy can be produced. This quasi-crystalline particle dispersed alloy bulk material is made of only a quasi-crystalline particle dispersed alloy having quasi-crystalline particles, so that strength in a high temperature environment can be enhanced.

According to the quasi-crystalline particle dispersed alloy clad material of the present invention, it can be formed into a thick plate or a structural member having a specific shape, in particular, a complicated shape while maintaining quasi-crystalline particles, so that the strength of the base material at high temperatures can be enhanced.

According to a quasi-crystalline particle dispersed alloy bulk material of the present invention, the bulk material can be formed into a thick plate or a structural member having a specific shape, in particular, a complicated shape made of only a quasi-crystalline particle dispersed alloy, and the strength of the base material at high temperatures can be enhanced.

### BRIEF DESCRIPTION OF THE DRAWINGS

FIG. 1 is an explanatory view describing schematically production of a quasi-crystalline particle dispersed alloy clad material according to the method for producing a quasi-crystalline particle dispersed alloy clad material of the present invention;

FIG. 2 is an explanatory view describing schematically production of a quasi-crystalline particle dispersed alloy bulk material according to the method for producing a quasi-crystalline particle dispersed alloy bulk material of the present invention;

FIG. 3 is a SEM (electron scanning microscope) cross-section photo of He-TP2 as a typical example of the quasi-crystalline particle dispersed alloy clad material obtained by using a He gas, with the scale bar equal to 200 micrometers;

FIG. 4 shows a diffraction pattern measured by applying X-ray diffraction to the surface of the quasi-crystalline particle dispersed alloy clad material of He-TP2 with the horizontal axis in the figure indicating the diffraction angle (20 (degrees)), and the vertical axis indicating the diffraction intensity (arbitrary unit);

FIG. 5(a) is a TEM (transmission electron microscope) photo of a central portion of the clad layer, He-TP2, taken under the conditions shown in Table 1 (the scale bar in the figure indicates 100 nanometers), and FIG. 5(b) is a TEM photo of an interface portion between the base material and the quasi-crystalline particle dispersed alloy of He-TP2 (the scale bar in the figure indicates 100 nanometers);

FIG. 6 is a SEM cross-section photo of N₂-TP7 as a typical example of the quasi-crystalline particle dispersed alloy clad material taken by using the N₂ gas with the scale bar equal to 200 micrometers;

FIG. 7 shows a diffraction pattern measured by applying X-ray diffraction to the surface of the quasi-crystalline particle dispersed alloy clad material of N₂-TP7 with the horizontal axis in the figure indicating the diffraction angle (2θ (degrees)) and the vertical axis indicating the diffraction intensity (arbitrary unit); and

FIG. 8 is a diagram showing the measured results of a cross-section hardness test of the quasi-crystalline particle dispersed alloy clad materials obtained by using He gas (He-TP2) and N₂ gas (N₂-TP7) as gas species.

### DESCRIPTION OF THE PREFERRED EMBODIMENTS

The gist of the present invention is that, by forming a quasi-crystalline particle dispersed alloy on the surface of a base material at a temperature lower than or equal to the decomposition temperature of the quasi-crystalline particles, a quasi-crystalline particle dispersed alloy clad material and a quasi-crystalline particle dispersed alloy bulk material as a thick plate or a structural member having a specific shape, in particular, a complicated shape are obtained, and a method for easily producing these is obtained.

As a result of intensive research, the inventors have found that the strength as a structural member is to be improved by suppressing crack generation on the surface of a base material (specifically, a metal base material), and that reinforcement of only the surface layer portion of the member for a structure, that is, only the surface layer portion of the base material is an effective means to suppress cracks on the surface of such a member for a structure without using a high strength material for the whole structural member. Based on the above findings they have completed the present invention.

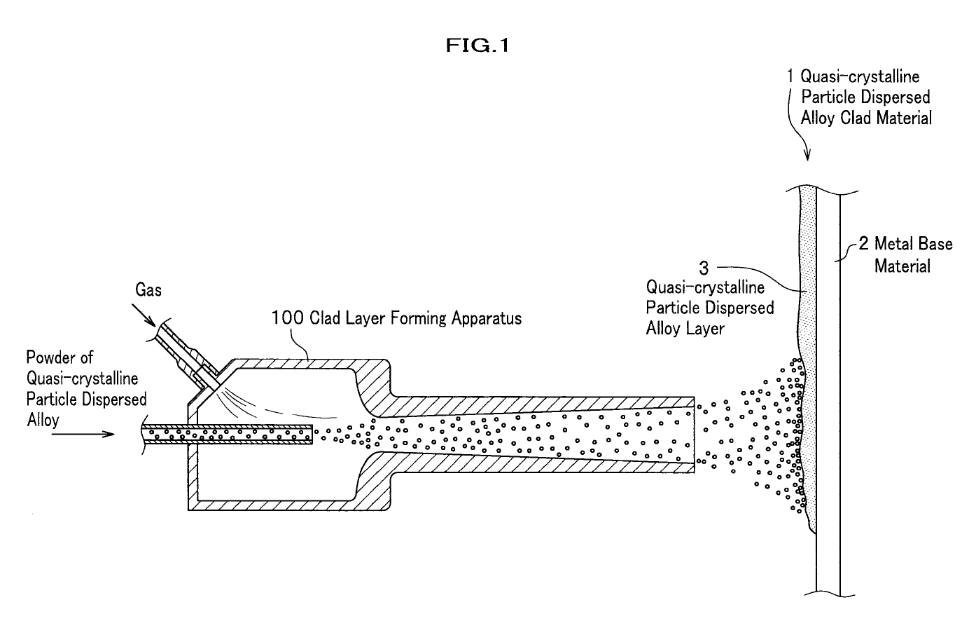

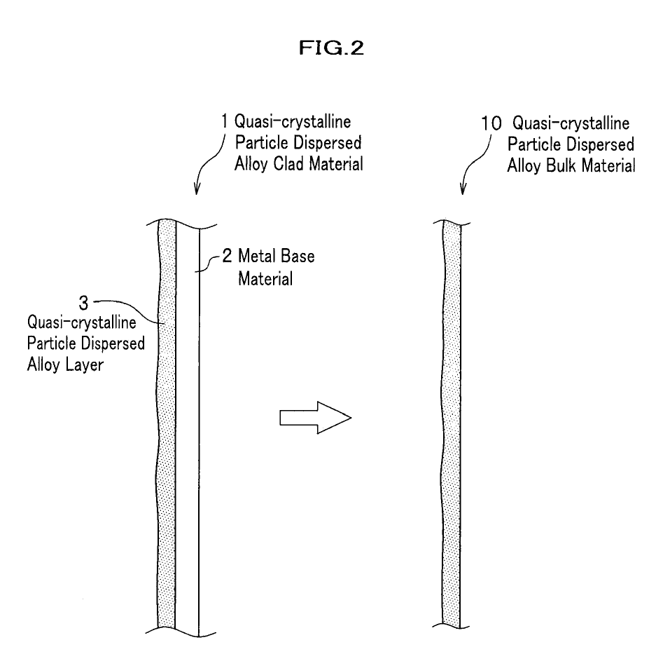

Hereinafter, a method for producing a quasi-crystalline particle dispersed alloy clad material, a method for producing a quasi-crystalline particle dispersed alloy bulk material, a quasi-crystalline particle dispersed alloy clad material, and a quasi-crystalline particle dispersed alloy bulk material of the present invention will be explained in detail with reference to the drawings as appropriate. Among the drawings to be referred to, FIG. 1 is an explanatory view describing production of a quasi-crystalline particle dispersed alloy clad material according to the method for producing a quasi-crystalline particle dispersed alloy clad material of the present invention, and FIG. 2 is an explanatory view describing production of a quasi-crystalline particle dispersed alloy bulk material according to the method for producing a quasi-crystalline particle dispersed alloy bulk material of the present invention.

First, the method for producing a quasi-crystalline particle dispersed alloy clad material of the present invention will be described.

As shown in FIG. 1, according to the method for producing a quasi-crystalline particle dispersed alloy clad material of the present invention, a quasi-crystalline particle dispersed alloy clad material 1 is produced by forming a quasi-crystalline particle dispersed alloy layer 3 containing quasi-crystalline particles dispersed in the matrix onto a base material 2 by a clad layer forming apparatus 100 at a temperature lower than or equal to the decomposition temperature of the quasi-crystalline particles.

Therefore, the quasi-crystalline particle dispersed alloy clad material 1 produced according to this production method has a structure in which a layer of a quasi-crystalline particle dispersed alloy (quasi-crystalline particle dispersed alloy layer 3) is formed on the surface of a base material 2 as shown in FIG. 1.

As the base material 2 used in the present invention, a base material which allows the quasi-crystalline particle dispersed alloy layer 3 to be formed thereon and has high affinity with this quasi-crystalline particle dispersed alloy layer can be preferably used.

By using the base material 2 with high affinity with the quasi-crystalline particle dispersed alloy, delamination between the base material 2 and the quasi-crystalline particle dispersed alloy layer 3 formed on the surface of the base material can be prevented even at high temperatures, and when it is used as a structural member, propagation of a crack is to be prevented even if cracks occur on its surface.

As the base material 2 that has high affinity with the quasi-crystalline particle dispersed alloy, a base material 2 that mainly contains a metal element of the same kind as the main metal element contained in the quasi-crystalline particle-disposed alloy is preferably used. For example, when the aluminum base alloy described in Japanese Laid-Open Patent Application No. 2006-274311 is used as the quasi-crystalline particle dispersed alloy layer, pure aluminum or aluminum alloy is used for the base material 2. For example, when the magnesium base alloy described in Japanese Laid-Open Patent Application No. 2005-113234 is used as the quasi-crystalline particle dispersed alloy layer, pure magnesium or magnesium alloy is used for the base material 2. As the base material 2 with high affinity with the quasi-crystalline particle-disposed alloy, a metal whose physical properties such as the thermal expansion coefficient and Young's modulus are equivalent to those of the quasi-crystalline particle dispersed alloy can be used as well as a metal of the same kind.

As the base material 2 that can be used in the present invention, of course, it is not especially limited and any material can be used as long as it allows the quasi-crystalline particle dispersed alloy layer 3 to be formed thereon. For example, calcium, manganese, and tin, etc., can be used.

On the other hand, when producing the quasi-crystalline particle dispersed alloy bulk material 10 to be described later, a base material 2 with low affinity with the quasi-crystalline particle dispersed alloy can be used. As is to be described later, the quasi-crystalline particle dispersed alloy bulk material 10 of the present invention can be obtained by removing the base material 2 in the production process. In order to facilitate the removal, it is possible to have the quasi-crystalline particle dispersed alloy layer 3 and the base material 2 intentionally delaminated from each other. As the base material 2 with low affinity with the quasi-crystalline particle dispersed alloy, for example, a metal-made base material such as iron, titanium, stainless steel, and magnesium can be used, and a nonmetallic base material such as ceramics, glass, and wood can be also used.

Herein, as the quasi-crystalline particle dispersed alloy layer containing quasi-crystalline particles dispersed in the matrix, for example, the aluminum base alloy described in Japanese Published Laid-Open Patent Application No. 2006-274311 and the magnesium base alloy described in Japanese Laid-Open Patent Application No. 2005-113234 can be preferably used. By using these matrix materials, a quasi-crystalline particle dispersed alloy layer 3 containing quasi-crystalline particles can be reliably obtained. The quasi-crystalline particle dispersed alloy that can be used in the present invention is not limited to these, and for example, the Al-14% Mn alloy (aluminum base alloy) described in D. Schechtman, I. Blech, D. Gratias, J. Cahn, “Metallic phase with long range orientational order and no translational symmetry,” Physical Review Letters, Vol. 53, pp. 1951-1954 (1984), the Al—Mn—Ce alloy described in A. Inoue, M. Watanabe, H. M. Kimura, F. Takahashi, A. Nagata and T. Masumoto, “High Mechanical Strength of Quasi-crystalline Phase Surrounded by fcc-Al Phase in Rapidly Solidified Al—Mn—Ce Alloys,” Materials Transactions, JIM, Vol. 33 No. 8, pp. 723-729 (1992), the Al—Cr—Ce—Co alloy (aluminum base alloy) described in A. Inoue, H. M. Kimura, K. Sasamori and T. Masumoto, “Ultrahigh Strength of Rapidly Solidified Al₉₆-xCr₃Ce₁Cox (x=1, 1.5 and 2%) Alloys Containing an Icosahedral Phase as a Main Component,” Materials Transactions, JIM, Vol. 35 No. 2, pp. 85-94 (1994), and the Mg—Zn—Al alloy (magnesium base alloy) described in Yuan G. Y., Amiya K., Kato H., Inoue A., “Structure and Mechanical Properties of Cast Quasicrystal-reinforced Mg-An—Al—Y Base Alloys,” Journal of Materials Research, 19(5), pp. 1531-1538 (2004), and in addition, gallium base alloys, palladium base alloys, titanium base alloys, chromium base alloys, and vanadium base alloys, etc., can also be used (refer to Shin Takeuchi, “Quasicrystals: new dream materials being neither crystal nor amorphous,” Sangyo Tosho, pp. 84).

The matrix of the quasi-crystalline particle dispersed alloy is preferably an aluminum crystalline phase or an aluminum supersaturated solid solution phase. When the matrix is an aluminum supersaturated solid solution phase, it is expected that the matrix strength is enhanced by solution hardening, and when the matrix is an aluminum crystalline phase, by utilizing the ductility thereof, a quasi-crystalline-dispersed alloy with high fracture toughness can be obtained.

In the present invention, the quasi-crystalline particle dispersed alloy layer must be formed on the surface of the base material 2 at a temperature lower than or equal to the decomposition temperature of the quasi-crystalline particles dispersed in the alloy. If the quasi-crystalline particle dispersed alloy layer is formed on the surface of the base material 2 at a temperature higher than the decomposition temperature of the quasi-crystalline particles, the structures of the quasi-crystalline particles decomposes. Accordingly the effect of enhancing the strength of the structural member, in particular, the strength at high temperatures, which results from the presence of the quasi-crystalline particles, cannot be obtained. The temperature for formation of the quasi-crystalline particle dispersed alloy layer is preferably lower than the decomposition temperature of the quasi-crystalline particles, and more preferably 30° C. lower than the decomposition temperature of the quasi-crystalline particles.

It is most preferable that the quasi-crystalline particle dispersed alloy layer 2 in the present invention is formed on the surface of the base material 2 while maintaining a solid phase condition of the quasi-crystalline particles at a temperature lower than or equal to the decomposition temperature of the quasi-crystalline particles. Accordingly, the alloy can be reliably formed on the surface of the base material 2 while maintaining the atomic structures of the quasi-crystalline particles.

Preferably, when it is desired to improve the adhesion between the quasi-crystalline particle dispersed alloy layer 3 and the base material 2, before forming the quasi-crystalline particle dispersed alloy layer 3, the surface of the base material 2 is subjected to roughening such as blast finishing. On the contrary, when it is desired to lower the adhesion between the quasi-crystalline particle dispersed alloy layer 3 and the base material 2, the surface of the base material 2 is preferably subjected to smoothing such as polishing before forming the quasi-crystalline particle dispersed alloy layer 3.

Desirably, the quasi-crystalline particle dispersed alloy layer 3 is formed at a temperature lower than or equal to the decomposition temperature of the quasi-crystalline particles after the quasi-crystalline particle dispersed alloy is powderized. However, the present invention is not limited to this, and for example, the alloy may be formed into a plate, chip, grains, or fine particles, and then formed.

When the powder is produced from the quasi-crystalline particle dispersed alloy, the maximum grain size of the powder is preferably 200 micrometers or less, and more preferably, 150 micrometers or less. The average grain size is preferably 0.1 to 50 micrometers. In the present invention, the smaller grain size of the quasi-crystalline particle dispersed alloy powder is preferable because the smaller the grain size of the quasi-crystalline particle dispersed alloy powder, the more homogeneous the quasi-crystalline particle dispersed alloy layer 3 becomes. However, the smaller grain size of the quasi-crystalline particle dispersed alloy powder tends to deteriorate the supply efficiency and flowability in the clad layer forming apparatus 100 and the workability and productivity may decrease. On the other hand, if the grain size of the quasi-crystalline particle dispersed alloy powder is excessively large, the formation of the quasi-crystalline particle dispersed alloy layer 3 may become difficult, or it may become impossible to obtain the quasi-crystalline particle dispersed alloy clad material 1 having a high quality quasi-crystalline particle dispersed alloy layer 3.

The maximum grain size and average grain size of the quasi-crystalline particle dispersed alloy powder can be controlled by adjusting the temperature and rotation speed of the roller of a single-roller liquid rapid quenching apparatus and the amount of a molten metal to be supplied to the roller when, for example, the aluminum base alloy described in Japanese Published Unexamined Patent Application No. 2006-274311 is used. The maximum grain size and average grain size of the quasi-crystalline particle dispersed alloy powder can be controlled instead by an atomizing method, a chemical alloying method, a mechanical alloying method, or the like, however, in view of productivity, among these, control by the atomizing method is preferable.

The layer thickness of the quasi-crystalline particle dispersed alloy layer 3 can be changed as appropriate according to the purpose of use, and it is preferably thicker than or equal to 1 micrometer, more preferably thicker than or equal to 10 micrometers, and still more preferably thicker than or equal to 100 micrometers. The upper limit of the layer thickness is not especially defined and can be determined according to the purpose, and normally, if the layer thickness is about 3 millimeters, generation of a crack on the base material 2 can be suppressed, and it is sufficient to improve the wear resistance.

The layer thickness of the quasi-crystalline particle dispersed alloy layer 3 can be controlled by changing the formation conditions thereof (for example, the gaseous species, gas pressure, gas temperature, and the supply amount of powder of the quasi-crystalline particle dispersed alloy). It can also be controlled by machining after formation of the quasi-crystalline particle dispersed alloy layer 3.

The layer thickness and area of the quasi-crystalline particle dispersed alloy layer 3 are not especially limited, and by selecting appropriate production conditions, the layer thickness and the area can be made larger than those described above.

The porosity of the quasi-crystalline particle dispersed alloy layer 3 can also be appropriately changed according to the purpose of use, however, porosity lower than or equal to 50% is preferable. To obtain the same properties of the aluminum base alloy described in Japanese Laid-Open Patent Application No. 2006-274311 in the quasi-crystalline particle dispersed alloy clad material 1 of the present invention, it is preferable that the porosity of the quasi-crystalline particle dispersed alloy layer 3 is minimized. However, to improve the functions of oil film retaining, heat conduction, and impact resistance, the porosity can also be controlled so as to increase. However, even in this case, if the porosity is higher than or equal to 50%, the quasi-crystalline particle dispersed alloy layer 3 may not function as expected.

Preferably, the form of the quasi-crystalline particles in the quasi-crystalline particle dispersed alloy layer is present as fine spherical particles, and the quasi-crystalline particles are homogeneously dispersed in the matrix. In detail, the average particle size of the quasi-crystalline particles is preferably set to 10 to 1000 nanometers. If the average particle size of the quasi-crystalline particles is smaller than 10 nanometers, they may hardly contribute to the strength of the quasi-crystalline particle dispersed alloy. On the other hand, if the average particle size of the quasi-crystalline particles is larger than 1000 nanometers, the function of the precipitated particles to strengthen the quasi-crystalline particle dispersed alloy may deteriorate.

The volume fraction of the quasi-crystalline particles contained in the quasi-crystalline particle dispersed alloy is preferably 20 to 80%. If the volume fraction of the quasi-crystalline particles is less than 20%, the quasi-crystalline particles cannot function as dispersed reinforcement particles, and if the volume fraction of the quasi-crystalline particles is more than 80%, the quasi-crystalline particle dispersed alloy may be extremely brittle. The volume fraction of the quasi-crystalline particles can be controlled by controlling the solute element amount and the cooling rate by considering the conditions of preparation of powder, etc., of the quasi-crystalline particle dispersed alloy, for example, the balance between the strength and ductility.

The quasi-crystalline particle dispersed alloy can be produced from a molten metal of a base alloy by a liquid rapid cooling method such as single-roller method, a double-roller method, various atomizing methods, and a spraying method, and a production method such as a sputtering method, a mechanical alloying method, and a mechanical grinding method.

As the clad layer forming apparatus 100 to be used in the present invention, an apparatus which can form the quasi-crystalline particle dispersed alloy layer 3 on the surface of the base material 2 by pressure-bonding, plating, vapor deposition, and thermal spraying at a temperature lower than or equal to the decomposition temperature of the quasi-crystalline particles, that is, in particular, a cold sprayer or a high velocity flame thermal spraying (HVOF) apparatus can be preferably used. When using a cold sprayer or an HVOF apparatus, it positively uses plastic deformation of a sprayed material accelerated by kinetic energy so that the quasi-crystalline particle heating temperature can be lowered. Therefore, formation of the quasi-crystalline particle dispersed alloy layer 3 at a temperature lower than or equal to the decomposition temperature of the quasi-crystalline particles is possible. When the quasi-crystalline particle dispersed alloy layer 3 is formed on the surface of the base material 2 by using a cold sprayer or an HVOF device, the quasi-crystalline particle dispersed alloy layer 3 can be formed only on a portion where formation of the quasi-crystalline particle dispersed alloy layer 3 is necessary, and accordingly, efficient improvement in properties is realized. By not forming the quasi-crystalline particle dispersed alloy layer 3 on a portion where it is not necessary, resource can be spared and cost reductions can be realized. The clad layer forming apparatus 100 that can be used in the present invention is not limited to these, and any apparatus can be used as long as it can perform formation at a temperature lower than or equal to the decomposition temperature of the quasi-crystalline particles.

The quasi-crystalline particle dispersed alloy clad material 1 produced according to the method for producing a quasi-crystalline particle dispersed alloy clad material of the present invention described above has the following features.

(1) In view of strength enhancement, for example, when the quasi-crystalline particles are decomposed into a compound in the production process of the quasi-crystalline particle dispersed alloy clad material 1 of the present invention, it is expected that this compound serves as a reinforcing factor and also contributes to the improvement in mechanical properties. In the quasi-crystalline particle dispersed alloy clad material 1 of the present invention, the fracture strength of the quasi-crystalline particle dispersed alloy layer 3 can be enhanced by a compressive residual stress generated at the time of clad layer formation. Further, the quasi-crystalline particle dispersed alloy containing quasi-crystalline particles is excellent not only in mechanical properties but also in wear resistance. Therefore, in the quasi-crystalline particle dispersed alloy clad material 1 of the present invention, by forming the quasi-crystalline particle dispersed alloy layer 3 on the surface of the base material 2, the wear resistance of the surface portion of a member for a structure can be efficiently improved.

In addition, by using metals of the same kind or metals with thermal expansion coefficients and Young's modulus equivalent to each other, for the base material 2 and the quasi-crystalline particle dispersed alloy, propagation of cracks involving exfoliation of these metals can be prevented. Even without an intermediate layer between these as in the conventional technique, the propagation of cracks that necessarily causes delamination can be prevented. Further, a technique for efficient partial reinforcement which enhances the strength of only a necessary portion of a member for a structure can also be provided.

(2) From the viewpoint of functions, it is also possible that, in the quasi-crystalline particle dispersed alloy clad material 1 of the present invention, heat conduction from the surface portion of the quasi-crystalline particle dispersed alloy clad material 1 to the base material 2 can be suppressed or promoted by forming the quasi-crystalline particle dispersed alloy layer 3 with a heat conductivity different from that of the base material 2. In other words, the quasi-crystalline particle dispersed alloy clad material 1 of the present invention can be used as a heat shielding coating or a good-heat-conductivity material.

In the quasi-crystalline particle dispersed alloy clad material 1 of the present invention, by forming a quasi-crystalline particle dispersed alloy layer 3 with an electric conductivity smaller than that of the base material 2 as the quasi-crystalline particle dispersed alloy layer 3, the insulation effect of the base material 2 can be improved.

Further, in the quasi-crystalline particle dispersed alloy clad material 1 of the present invention, by forming the quasi-crystalline particle dispersed alloy layer 3 with corrosion resistance more excellent than that of the base material 2, the corrosion resistance of the base material 2 can be improved.

(3) From the viewpoint of further improvement, the quasi-crystalline particle dispersed alloy clad material 1 is heat-treated at a temperature lower than or equal to the decomposition temperature of the quasi-crystalline particles to reduce the porosity of the quasi-crystalline particle dispersed alloy layer 3. Accordingly, solid phase diffusion of the matrix is induced, and the quasi-crystalline particle dispersed alloy layer 3 can be homogenized.

It is also possible that the porosity is reduced by applying plastic deformation such as rolling or pressing the quasi-crystalline particle dispersed alloy layer 3 at a temperature lower than or equal to the decomposition temperature of the quasi-crystalline particles within a plastic deformation range in which the quasi-crystalline particle dispersed alloy layer 3 can withstand the plastic deformation it undergoes.

In order to avoid delamination between the base material 2 and the quasi-crystalline particle dispersed alloy layer 3, which is caused by differences in properties such as Young's modulus, thermal expansion coefficient, and heat conductivity, by forming an intermediate layer of a metal material which have properties intermediate between the properties of the base material 2 and the quasi-crystalline particle dispersed alloy layer 3, a quasi-crystalline particle dispersed alloy clad material 1, in which rapid changes in properties between the base material 2 and the quasi-crystalline particle dispersed alloy layer 3 are reduced and delamination of these is prevented, can be produced.

A desired surface state can be obtained by polishing, mechanical polishing, chemical polishing, or electropolishing the surface of the quasi-crystalline particle dispersed alloy clad material 1 of the present invention. The layer thickness can also be changed locally.

Next, a method for producing a quasi-crystalline particle dispersed alloy bulk material of the present invention will be described.

As shown in FIG. 2, in the method for producing a quasi-crystalline particle dispersed alloy bulk material of the present invention, the quasi-crystalline particle dispersed alloy clad material 1 produced according to the above-described method for producing a quasi-crystalline particle dispersed alloy clad material is used, and a quasi-crystalline particle dispersed alloy bulk material 10 is produced by removing the base material 2 from this quasi-crystalline particle dispersed alloy clad material 1.

Therefore, the quasi-crystalline particle dispersed alloy bulk material 10 produced by this production method has a structure composed of only the quasi-crystalline particle dispersed alloy layer 3 as shown in FIG. 2.

The method for producing the quasi-crystalline particle dispersed alloy bulk material 10 of the present invention is the same as the above-described method for producing the quasi-crystalline particle dispersed alloy clad material 1 except that the base material 2 is removed from the quasi-crystalline particle dispersed alloy clad material 1, and part of the description on the method overlaps and only the process of removing the base material 2 will be described mainly.

It is possible to remove the base material 2 from the quasi-crystalline particle dispersed alloy clad material 1 by a mechanical means or a chemical means, and by any of these means, only the base material 2 can be preferably removed. Herein, as a mechanical means for removing the base material 2, for example, grinding is utilized. It is possible to remove only the base material by grinding with a grinding machine. It is also possible to do so by using a base material 2 with low affinity with the quasi-crystalline particle dispersed alloy to be formed thereon. In this case only the base material 2 is removed by delaminating the base material from the quasi-crystalline particle dispersed alloy clad material 1. As a chemical means for removing the base material 2, for example, the base material 2 is dissolved with an arbitrary chemical such as an acid solution and removed. The means for removing the base material 2 which can be used in the present invention is not limited to these.

As a matter of course, the quasi-crystalline particle dispersed alloy bulk material 10 of the present invention thus produced has the same features as those of the quasi-crystalline particle dispersed alloy clad material 1 in terms of (1) strength enhancement, (2) functions, and (3) improvement potential.

### EXAMPLES

Next, examples in which the effects of the present invention were confirmed will be described.

### Example 1

By using the cold sprayer (manufactured by Plasma Giken Kogyo) schematically shown in FIG. 1, under the cold spray conditions shown in Table 1, a quasi-crystalline particle dispersed aluminum alloy in the form of powder with the powder composition and powder particle size shown in Table 1 was formed onto two aluminum alloy-made base materials (A5052 alloy regulated in JIS H4000 (hereinafter, referred to as “A5052”)). As shown in Table 1, the cold spray conditions onto two base materials differ in gas temperature from each other, and quasi-crystalline particle dispersed alloy clad materials prepared under the respective conditions were defined as He-TP1 and He-TP2. In [Example 1], as a gaseous species of a working medium, a He gas was used.

TABLE 1

| Sample name | He-TP1 | | He-TP2 | |
|---|---|---|---|---|
| Gas species | He | | | |
| Powder composition | AL_{94.96}Fe_{1.68}Cr_{2.24}Ti_{0.56}Co_{0.56} | | | |
| Powder particle size | Average: 14.14 μm (150 μm max.) | | | |
| Base material | A5052 | | | |
| Base material size | 50 × 50 × 10 (mm) | | | |
| Base material surface | Shot blasting | | | |
| treatment | | | | |
| Nozzle-base material distance | 20 | | (mm) | |
| Gun traverse | 100 | | (mm/s) | |
| Gun traverse pitch | 1 | | (mm) | |
| Gas pressure | 3 | (MPa) | 3 | (MPa) |
| Gas temperature | 100 | (° C.) | 200 | (° C.) |
| Coating layer thickness | 500 | (μm) | 500 | (μm) |

In both of He-TP1 and He-TP2, a dense coating layer with a layer thickness of 500 micrometers was obtained. However, the layer thickness can be adjusted by increasing or reducing the number of the formation processes.

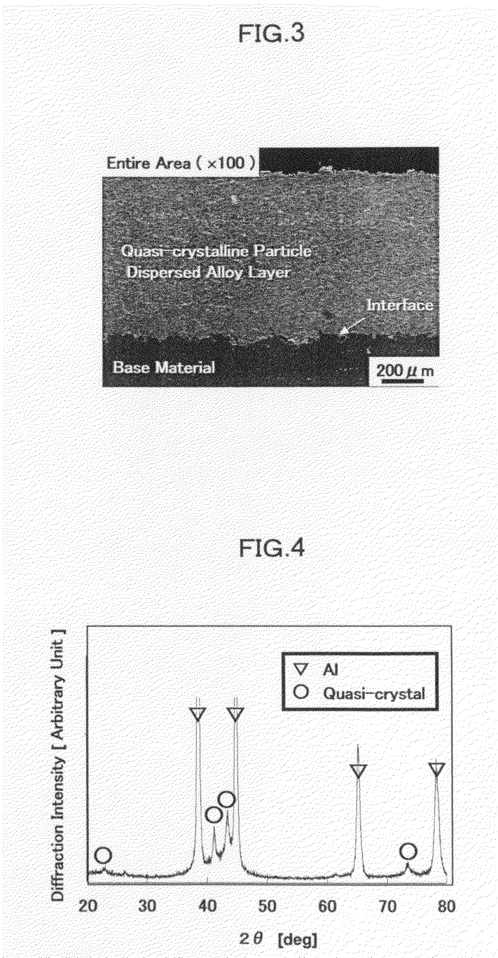

As a typical example of the quasi-crystalline particle dispersed alloy clad material obtained by using a He gas, a photo of a SEM (electron scanning microscope) cross-section photo of He-TP2 is shown in FIG. 3. The scale bar in the figure indicates 200 micrometers. From this SEM cross-section photo, it proves that a dense coating layer with a layer thickness of about 500 micrometers has been formed.

A diffraction pattern measured by applying X-ray diffraction to the surface of the quasi-crystalline particle dispersed alloy clad material of He-TP2 is shown in FIG. 4. In FIG. 4, the horizontal axis indicates the diffraction angle (20 (degrees)), and the vertical axis indicates the diffraction intensity (arbitrary unit).

As shown in FIG. 4, the quasi-crystalline particle dispersed alloy clad material of He-TP2 clearly shows those of peaks (peaks shown as “O” in FIG. 4) of the quasi-crystalline particles that correspond to the quasi-crystalline particle dispersed alloy in the form of powder, and it has become clear that even after the powder of the quasi-crystalline particle dispersed alloy is formed onto the base material by a cold sprayer, this quasi-crystalline particle dispersed alloy formed onto the base material maintains the quasi-crystalline particles. “∇” in FIG. 4 indicates a peak of aluminum (Al).

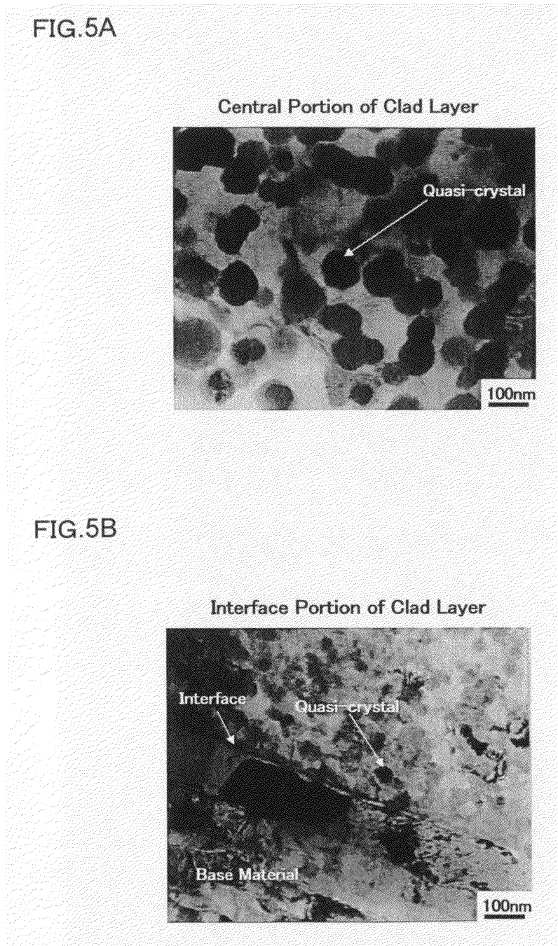

A TEM (transmission electron microscope) photo of the central portion (that is, near 250 micrometers in the formation thickness direction) of the quasi-crystalline particle dispersed alloy clad material (He-TP2) taken under the conditions shown in Table 1 is shown in FIG. 5(a). The scale bar in the figure indicates 100 nanometers. As shown in FIG. 5(a), it becomes clear that the quasi-crystalline particles are maintained at the central portion of the quasi-crystalline particle dispersed alloy layer.

FIG. 5(b) shows a TEM photo of an interface portion between the base material and the quasi-crystalline particle dispersed alloy of the same He-TP2. The scale bar in the figure indicates 100 nanometers. As shown in FIG. 5(b), no mark of melting of the quasi-crystalline particles is observed at the interface portion, and it became clear that solid-phase bonding was performed while maintaining the quasi-crystalline particles.

### Example 2

By using the cold sprayer schematically shown in FIG. 1, a quasi-crystalline particle dispersed aluminum alloy in the form of powder with the powder composition and powder particle size shown in Table 2 was formed onto eight aluminum alloy-made base materials (A5052) under the cold spray conditions shown in Table 2. As shown in Table 2, the cold spray conditions onto the eight base materials are different in gas pressure, gas temperature, and coating layer thickness from each other, and quasi-crystalline particle dispersed alloy clad materials made under the respective conditions were defined as N₂-TP1 though N₂-TP8. In [Example 2], as a gas species of a working medium, an N₂ gas was used.

TABLE 2

| Sample name | N₂₋TP1 | N₂₋TP2 | N₂₋TP3 | N₂₋TP4 | N₂₋TP5 | N₂₋TP6 | N₂₋TP7 | N₂₋TP8 |
|---|---|---|---|---|---|---|---|---|
| Gas species | N₂ | | | | | | | |
| Powder composition | AL_{94.96}Fe_{1.68}Cr_{2.24}Ti_{0.56}Co_{0.56} | | | | | | | |
| Powder particle size | Average: 14.14 μm (150 μm max.) | | | | | | | |
| Base material | A5052 | | | | | | | |
| Base material size | 50 × 50 × 10 (mm) | | | | | | | |
| Base material surface | Shot blasting | | | | | | | |
| treatment | | | | | | | | |
| Nozzle-base material | 20 | | | | (mm) | | | |
| distance | | | | | | | | |
| Gun traverse | 100 | | | | (mm/s) | | | |
| Gun traverse pitch | 1 | | | | (mm) | | | |
| Gas pressure | 3 (MPa) | 3 (MPa) | 3 (MPa) | 3.6 (MPa) | 3.7 (MPa) | 3.6 (MPa) | 3.6 (MPa) | 3.6 (MPa) |
| Gas temperature | 200 (° C.) | 300 (° C.) | 400 (° C.) | 300 (° C.) | 400 (° C.) | 400 (° C.) | 400 (° C.) | 400 (° C.) |
| Coating layer thickness | 50 (μm) | 50 (μm) | 50 (μm) | 100 (μm) | 200 (μm) | 600 (μm) | 600 (μm) | 600 (μm) |

As shown in Table 2, in all of the quasi-crystalline particle dispersed alloy clad materials N₂-TP1 through N₂-TP8, a dense coating layer was obtained. Accordingly, it was also confirmed that the layer thickness could be adjusted by increasing or reducing the number of the formation processes.

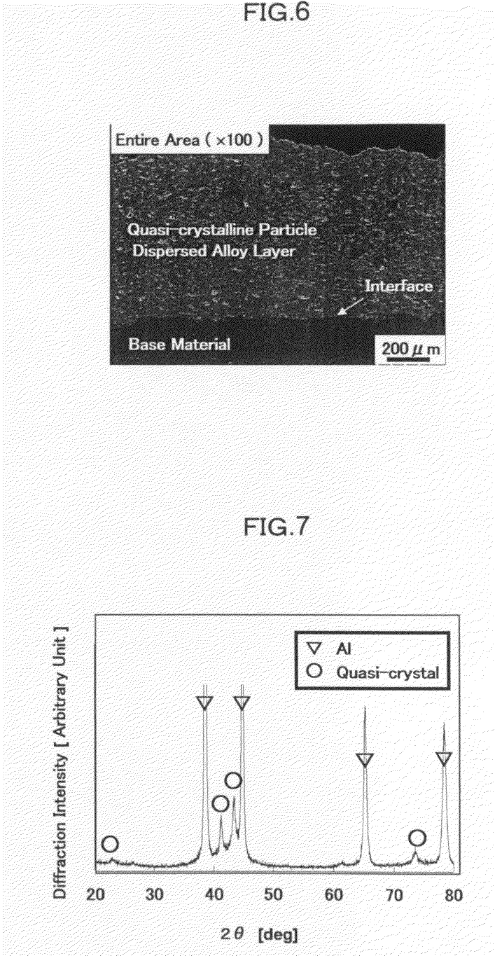

As a typical example of the quasi-crystalline particle dispersed alloy clad material obtained using the N₂ gas, a SEM cross-section photo of N₂-TP7 is shown in FIG. 6. The scale bar in the figure indicates 200 micrometers. From FIG. 6, it proves that a dense coating layer with a layer thickness of 600 micrometers is formed in the quasi-crystalline particle dispersed alloy clad material of N₂-TP7.

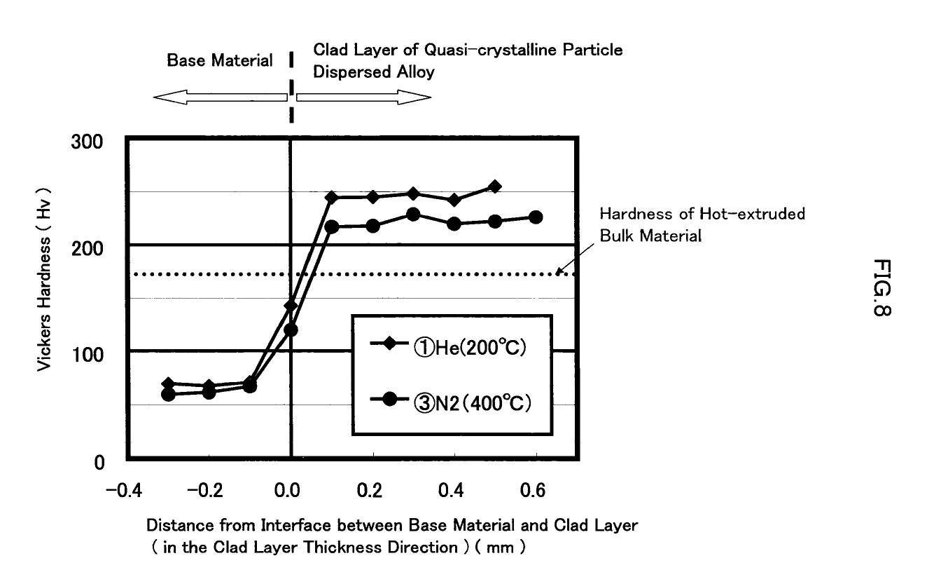

A diffraction pattern measured by applying X-ray diffraction to the surface of the quasi-crystalline particle dispersed alloy clad material of N₂-TP7 is shown in FIG. 7. In the figure, the horizontal axis indicates the diffraction angle (2θ (degrees)), and the vertical axis indicates the diffraction intensity (arbitrary unit).

As shown in FIG. 7, the quasi-crystalline particle dispersed alloy clad material of N₂-TP7 clearly shows peaks (peaks shown as “O” in FIG. 7) of the quasi-crystalline particles that correspond to those of the quasi-crystalline particle dispersed alloy in the form of powder, and it became clear that even after the powder of the quasi-crystalline particle dispersed alloy was formed onto the base material by a cold sprayer, the quasi-crystalline particle dispersed alloy formed onto the base material maintains the quasi-crystalline particles. “∇” in FIG. 7 indicates a peak of aluminum (Al).

### Example 3

In FIG. 8, the results of a section hardness test of the quasi-crystalline particle dispersed alloy clad materials obtained by using He gas (He-TP2) and N₂ gas (N₂-TP7) as gas species are shown. The section hardness test of the quasi-crystalline particle dispersed alloy clad material was conducted according to the Vickers hardness test regulated in JIS Z2244 at 0.2 N (200 gf load). The horizontal axis in the figure indicates the distance from the base material-coating interface (in the film thickness direction) (mm), and the vertical axis indicates the Vickers hardness (Hv).

Both of He-Tp2 and N₂-TP7 show hardness about three times the hardness of the base material, and it was confirmed that the formed quasi-crystalline particle dispersed alloy layer functions as a reinforcing layer. The reason for the higher hardness in the case of He gas in comparison with N₂ gas is that the flow rate of the particles of the quasi-crystalline particle dispersed alloy becomes higher and the powder deformation amount becomes larger in the case using the He gas. As reference, the Vickers hardness was also measured for a hot extruded bulk material of the quasi-crystalline particle dispersed alloy under the same conditions, and the hardness thereof was confirmed (the Vickers hardness of the hot extruded bulk material is shown by a dotted line in FIG. 8), and it was proved that the hardness of the quasi-crystalline particle dispersed alloy clad material satisfying the requirements of the present invention was higher than that of the hot extruded bulk material. The reason for this is considered that the matrix was work-hardened while making the quasi-crystalline particle dispersed alloy clad material.

### Example 4

Next, by using the cold sprayer schematically shown in FIG. 1, under the cold spray conditions shown in Table 3, a quasi-crystalline particle dispersed aluminum alloy in the form of powder with the powder composition and powder particle size shown in Table 3 was formed onto the aluminum alloy-made base material (A5052) to a layer thickness of about 1 millimeters, whereby a quasi-crystalline particle dispersed alloy clad material was obtained.

Then, by grinding the base material portion of this quasi-crystalline particle dispersed alloy clad material, a quasi-crystalline particle dispersed alloy bulk material made of only the quasi-crystalline particle dispersed alloy could be produced.

TABLE 3

| Powder composition | AL_{94.96}Fe_{1.68}Cr_{2.24}Ti_{0.56}Co_{0.56} | |
|---|---|---|
| Gas species | He | |
| Powder particle size | Average: 14.14 μm (150 μm max.) | |
| Base material | A5052 | |
| Base material size | 50 × 50 × 10 (mm) | |
| Base material surface | Shot blasting | |
| treatment | | |
| Nozzle-base material distance | 20 | (mm) |
| Gun traverse | 100 | (mm/s) |
| Gun traverse pitch | 1 | (mm) |
| Gas pressure | 3.6 | (MPa) |
| Gas temperature | 400 | (° C.) |

What is claimed is:

1. A method for producing a quasi-crystalline particle dispersed alloy clad material, comprising
forming with a clad layer forming apparatus a quasi-crystalline particle dispersed alloy layer, which is composed of a matrix and quasi-crystalline particles dispersed in the matrix, on a base material at a temperature lower than or equal to a decomposition temperature of the quasi-crystalline particles.

2. The method for producing a quasi-crystalline particle dispersed alloy clad material according to claim 1,
wherein the quasi-crystalline particle dispersed alloy layer is formed of a quasi-crystalline particle dispersed alloy in a solid phase condition at the temperature lower than or equal to the decomposition temperature of the quasi-crystalline particles.

3. The method for producing a quasi-crystalline particle dispersed alloy clad material according to claim 2,
wherein the quasi-crystalline particle dispersed alloy is an aluminum base alloy.

4. The method for producing a quasi-crystalline particle dispersed alloy clad material according to claim 3,
wherein the matrix is made of an aluminum crystalline phase or an aluminum supersaturated solid solution phase.

5. The method for producing a quasi-crystalline particle dispersed alloy clad material according to claim 1,
wherein the clad layer forming apparatus is a cold sprayer.

6. A method for producing a quasi-crystalline particle dispersed alloy bulk material from, comprising
producing a quasi-crystalline particle dispersed alloy clad material according to the method of claim 1, and
removing the base material from the quasi-crystalline particle dispersed alloy clad material.

7. A quasi-crystalline particle dispersed alloy clad material comprising
a base material and
a quasi-crystalline particle dispersed alloy layer which is formed on the base material and composed of a matrix and quasi-crystalline particles dispersed in the matrix.

8. The quasi-crystalline particle dispersed alloy clad material according to claim 7,
wherein the quasi-crystalline particle dispersed alloy is formed of a quasi-crystalline particle dispersed alloy in a solid phase condition at a temperature lower than or equal to a decomposition temperature of the quasi-crystalline particles.

9. The quasi-crystalline particle dispersed alloy clad material according to claim 8,
wherein the quasi-crystalline particle dispersed alloy is an aluminum base alloy.

10. The quasi-crystalline particle dispersed alloy clad material according to claims 9,
wherein the matrix is made of an aluminum crystalline phase or an aluminum supersaturated solid solution phase.

11. A quasi-crystalline particle dispersed alloy bulk material produced by removing a base material after forming on the base material a quasi-crystalline particle dispersed alloy layer which is composed of a matrix and quasi-crystalline particles dispersed in the matrix.

12. The quasi-crystalline particle dispersed alloy bulk material according to claim 11,
wherein the quasi-crystalline particle dispersed alloy layer is formed of a quasi-crystalline particle dispersed alloy in a solid phase condition at a temperature lower than or equal to a decomposition temperature of the quasi-crystalline particles.

13. The quasi-crystalline particle dispersed alloy bulk material according to claim 12,
wherein the quasi-crystalline particle dispersed alloy is an aluminum base alloy.

14. The quasi-crystalline particle dispersed alloy bulk material according to claims 13,
wherein the matrix is made of an aluminum crystalline phase or an aluminum supersaturated solid solution phase.
